(19) United States
(12) Patent Application Publication
(10) Pub. No.: US 2004/0150948 A1
(43) Pub. Date: Aug. 5, 2004

(54) System utilizing constrained layer damping material for control of rotational vibration

(76) Inventor: Kenneth K. Tang, Sacramento, CA (US)

Correspondence Address: HEWLETT-PACKARD COMPANY, Intellectual Property Administration, P.O. Box 272400, Fort Collins, CO, 80527-2400, US

(21) Appl. No.: 10/356,256

(22) Filed: Jan. 31, 2003

(51) Int. Cl. G06F 1/16

(52) U.S. Cl. 361/685

(57) ABSTRACT

An apparatus comprises an electronic device with a device chassis. The electronic device further has a drive mounted in the device chassis. A constrained layer damping material is connected to the electronic device in a manner to control rotational vibration initiated by the drive.

### BACKGROUND OF THE INVENTION

Rotational vibration can be induced in a variety of systems by components that utilize rotatable parts. For example, drives, such as disk drives used in high performance storage array products, often create rotational vibrations. The rotational vibrations can inhibit system performance by, for example, slowing read/write operations of the disk drives.

As the data density and data access performance from each generation of disk drives increases, the detrimental impact of rotational vibrations also increases. Attempts have been made to limit the effects of rotational vibration by adding polymer and foam grommets to isolate transmission of vibration to the surrounding device chassis; by creating a heavy disk drive carrier; by increasing external chassis stiffness via rigid structural disk bays; or by incorporating rotational vibration control springs at the carrier to disk bay interfaces. However, each of these approaches is undesirable due to factors, such as complexity, cost, increased part counts and excess weight.

### SUMMARY

In one embodiment of the present invention, a disk drive system is provided. The system utilizes a disk drive and a carrier in which the disk drive is mounted. The carrier comprises a constrained layer damping material to control rotational vibration of the disk drive.

In another embodiment, an apparatus comprises an electronic device. The electronic device has a chassis and a drive mounted in the chassis. The drive produces rotational vibration when operated. Additionally, the electronic device has a constrained layer damping material connected to the electronic device in a manner to control the rotational vibration.

In another embodiment, a method is provided for reducing rotational vibration in an electronic device. The method comprises forming a vibration reduction material by placing a thin viscoelastic core between stiffer sheets. The method further comprises mounting the vibration reduction material to the electronic device in the path of induced rotational vibration.

### BRIEF DESCRIPTION OF THE DRAWINGS

Certain embodiments of the invention will hereafter be described with reference to the accompanying drawings, wherein like reference numerals denote like elements, and:

FIG. 1 is a perspective view of an electronic device utilizing at least one drive module according to an embodiment of the present invention;

FIG. 2 is a front perspective view of one of the drive modules illustrated in FIG. 1 according to an embodiment of the present invention;

FIG. 3 is a perspective view of an embodiment of the carrier used with the drive module illustrated in FIG. 2 according to an embodiment of the present invention;

FIG. 4 is a perspective view of an external side of the guide rails illustrated in FIG. 3 according to an embodiment of the present invention;

FIG. 5 is a perspective view of an internal side of the guide rails illustrated in FIG. 3 according to an embodiment of the present invention; and

FIG. 6 is a cross-sectional view taken generally along line 6-6 of FIG. 3 according to an embodiment of the present invention.

### DETAILED DESCRIPTION

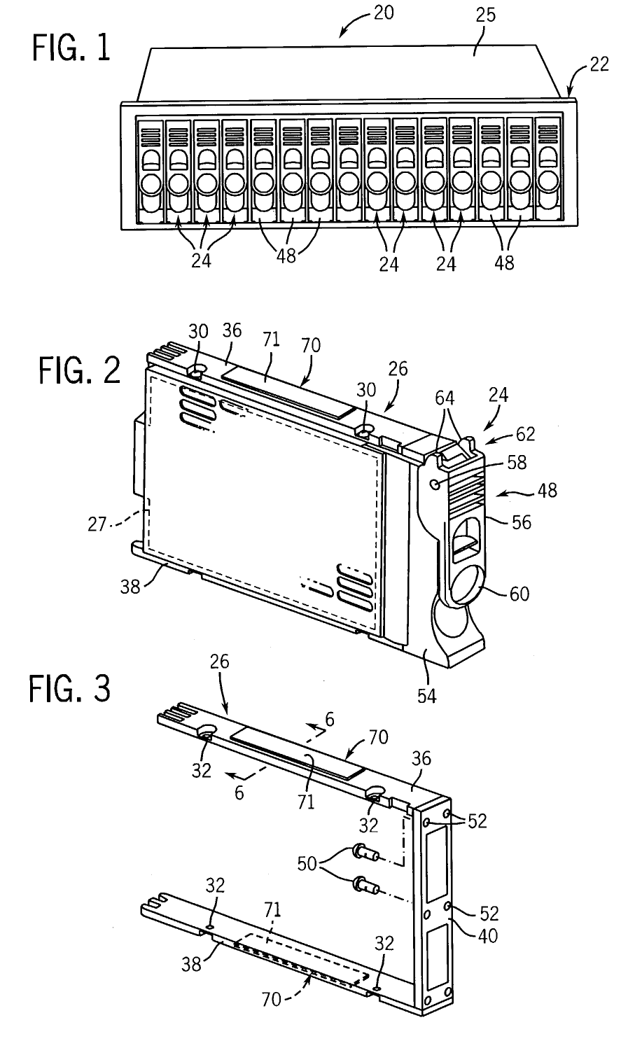

Referring generally to FIG. 1, a system 20 is illustrated in which rotational vibration is suppressed, according to an embodiment of the present invention. System 20 comprises an electronic device, such as a computer-based device 22, e.g. a high performance storage array product. Within computer-based device 22, there may be components with rotating members that establish rotational vibration within the overall system 20.

For example, computer-based device 22 may comprise at least one drive module 24, e.g. a disk drive module. In the specific embodiment illustrated, a plurality of disk drive modules 24 are mounted within a chassis 25. Each of the disk drive modules 24 is capable of establishing rotational vibration that is controlled within system 20 by a vibration control mechanism 26 (see FIG. 2) deployed in the path of induced rotational vibration. The vibration control mechanism 26 may be utilized in a variety of locations within system 20. For example, mechanism 26 may be incorporated into or attached to various structural members within chassis 25 of device 22. One example of a drive module incorporating vibration control mechanism 26 is illustrated in FIGS. 2 through 6.

Referring generally to FIG. 2, drive module 24 is a disk drive module comprising a disk drive 27 mounted within a carrier 28. By way of example, disk drive 27 may be affixed within carrier 28. In the embodiment illustrated, a plurality of fasteners 30 affix disk drive 27 and carrier 28. For example, fasteners 30 may comprise a plurality of screws that extend through corresponding openings 32 (see FIG. 3) in carrier 28 for threaded engagement with disk drive 27.

It should be noted that disk drive 27 is an example of one type of device that produces rotational vibration. There may be a wide variety of other types of drives or devices that induce rotational vibration into a system, such as system 20. These other devices/drives also can benefit from combination with a carrier, such as carrier 28, and vibration control mechanism 26.

Carrier 28 may have various configurations depending on the specific environment and application in which it is utilized. However, the illustrated carrier 28 comprises an overall carrier housing 34 having a first guide rail 36 and a second guide rail 38. Guide rails 36 and 38 are disposed generally parallel to one another and are linked together by a structural cross member 40, as illustrated best in FIG. 3.

Housing 34 also may comprise additional enclosure components, such as cover member 42. In the embodiment illustrated, cover member 42 comprises a ventilated portion 44 that extends between guide rails 36 and 38. Additionally, cover member 42 may comprise side panels 46 that each extend generally at a right angle with respect to ventilated portion 44. Side panels 46 are spaced to lie adjacent the inside surface of guide rails 36 and 38. When carrier 28 is coupled to disk drive 27, fasteners 30 may be inserted through openings 32 formed in guide rails 36, 38 and through side panels 46 to simultaneously secure guide rails 36, 38 and cover member 42 to disk drive 27.

Additionally, carrier 28 may comprise a bezel assembly 48. Bezel assembly 38 is disposed across a front of the drive module 24 and may be secured to structural cross member 40. Cross member 40 may be secured by a plurality of fasteners 50, such as screws, that extend through corresponding openings 52 in cross member 40 for threaded engagement with bezel assembly 48 (see FIG. 3).

Bezel assembly 48 may have a variety of configurations and components. However, in the example illustrated, bezel assembly 48 comprises a base portion 54 to which a handle assembly 56 is pivotably attached via a pivot 58. Handle assembly 56 comprises a handle 60 and a latch portion 62 having at least one protruding engagement feature 64. When handle 60 is moved to a closed position, as illustrated in FIGS. 1 and 2, engagement features 64 extend outwardly to prevent inadvertent removal of the drive module 24 from surrounding chassis 25, such as a storage enclosure disk bay chassis. However, when handle 60 is pulled outwardly to create a pivoting motion about pivot 58, engagement features 64 are pivoted inwardly to a position where interference with surrounding chassis 25 is no longer created. When handle assembly 56 is in this disengaged position, the drive module 24 may be removed from its surrounding chassis 25.

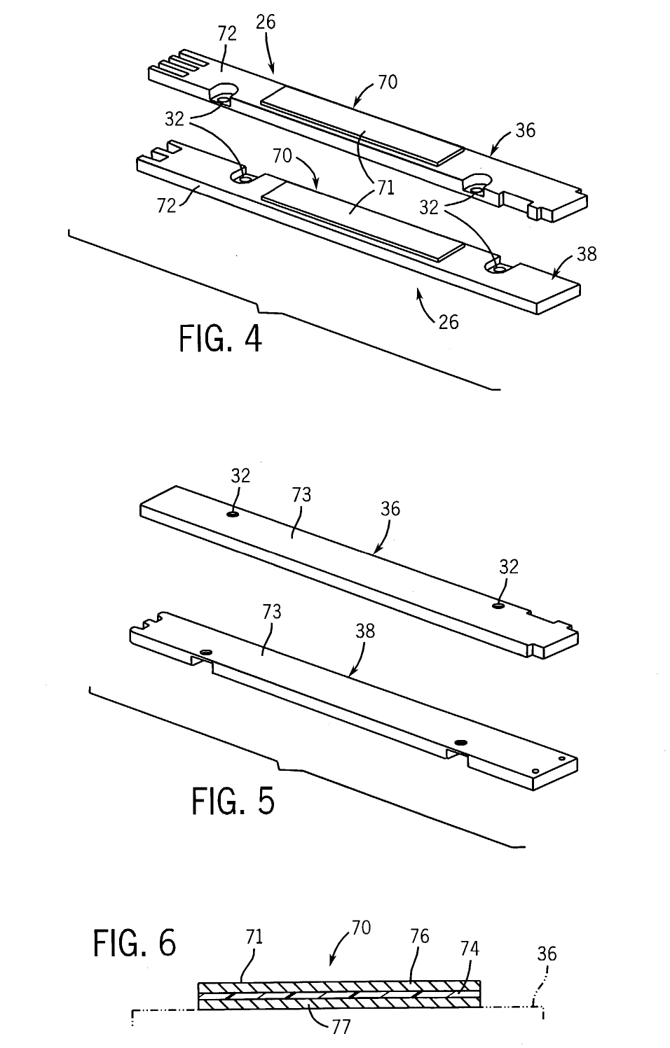

Guide rails 36 and 38 are designed to facilitate control, e.g. suppression, of rotational vibration. In one embodiment of guide rails 36 and 38 illustrated in FIGS. 4, 5 and 6, vibration control mechanism 26 is incorporated into carrier 28 via the guide rails. At least one of the guide rails incorporates the vibration control mechanism 26 in the form of a constrained layer damping material 70. However, both guide rails utilize the damping material 70 in the illustrated embodiment.

Constrained layer damping material 70 may be incorporated into various components of carrier 28 or chassis 25. However, the illustrated carrier 28 provides one example of how constrained layer damping material 70 can be used in the path of vibration to suppress the rotational vibration initiated by a given disk drive or other drive module 24. In this example, constrained layer damping material 70 is incorporated into guide rails 36 and 38 to dissipate vibration energy and thereby reduce rotational vibration that would otherwise affect the overall system 20. The rotational vibration suppression capabilities of the constrained layer damping material 70 allows, among other things, reduction of the “tightness of fit” requirement between the modules 24 and the surrounding chassis 25. Such an approach ultimately results in lower defects and an associated cost reduction for chassis manufacturers.

Constrained layer damping material 70 may be incorporated into guide rail 36 and/or guide rail 38 as well as other components in the path of induced vibration by a variety of mechanisms. For example, the constrained layer damping material may be affixed to the guide rail or other component by screws, adhesives, or other fasteners. Additionally, constrained layer damping material 70 may be integrally molded or otherwise incorporated into the material or materials used to construct the vibration control component e.g. guide rails 36, 38. In the embodiment illustrated, for example, each guide rail 36, 38 comprises an insert 71 formed of constrained layer damping material 70 and attached to an adjacent guide rail portion 72. Adjacent guide rail portion 72 may be formed of metal or plastic materials, such as an injection molded plastic.

With respect to guide rails 36 and 38, insert 71 may be incorporated into surrounding adjacent guide rail portion 72 in a variety of ways. For example, the insert 71 may be attached generally to an exterior side of each guide rail, as illustrated in FIG. 4. Opposite insert 71, each guide rail 36 and 38 has a generally flat interior surface 73 (see FIG. 5) designed to abut side panels 46 of cover member 42 when secured to drive 27. However, insert 71 may be deployed along interior surface 73, within adjacent guide rail portion 72 or at other positions along one or both of the guide rails.

Referring generally to FIG. 6, one example of constrained layer damping material 70 comprises a core material 74, such as a viscoelastic material, sandwiched between sheets 76, 77 of a stiffer material. However, constrained layer damping material 70 can have additional interleaved layers of viscoelastic material 74 and sheets 76, 77. Additionally, the viscoelastic material 74, as well as the sheets 76, may be formed of composite materials or mixtures of materials selected to suppress rotational vibration.

In the example illustrated, sheets 76, 77 are formed of a metal, such as steel, and viscoelastic material 74 is a viscoelastic polymer. Suitable constrained layer damping materials for use in suppressing rotational vibration in a disk drive carrier are available from Material Science Corporation of Elk Grove Village, Ill. in which sheets 76, 77 are formed of 0.015 inch HDG CS G40, and the viscoelastic core comprises PCX-1.229. The constrained layer damping material 70 dissipates vibration energy at the viscoelastic material 74 by converting vibration energy, exhibited through a shearing motion between sheets 76 and 77, into negligible heat.

Constrained layer damping material 70 has an inherent vibration damping characteristic that controls rotational vibration without detrimental carrier weight increases. Material 70 serves as an interface between the source of vibration, e.g. the disk drive, and the enclosure chassis, such as chassis 25. The cooperation between viscoelastic material 74 and sheets 76, 77 reduces the displacement and amplification of vibration energies in the overall system. For example, rotational vibration energy from the disk drive is dissipated.

While the subject matter described herein may be susceptible to various modifications and alternative forms, specific embodiments have been shown by way of example. However, it should be understood that the subject matter is not intended to be limited to the particular forms disclosed. Rather, the subject matter is to cover modifications, equivalents and alternatives falling within the spirit and scope of the subject matter as defined by the following appended claims.

What is claimed is:

1. A disk drive system, comprising:
a disk drive; and
a carrier in which the disk drive is mounted, the carrier comprising a constrained layer damping material to control rotational vibration of the disk drive.

2. The disk drive system as recited in claim 1, wherein the carrier comprises a plurality of guide rails, each guide rail being formed at least partially with the constrained layer damping material.

3. The disk drive system as recited in claim 2, wherein each guide rail comprises an injection molded plastic material and a constrained layer damping material insert.

4. The disk drive system as recited in claim 2, wherein the constrained layer damping material comprises a pair of layers sandwiching a core material.

5. The disk drive system as recited in claim 4, wherein the pair of layers are formed of a metallic material.

6. The disk drive system as recited in claim 4, wherein the core material comprises a viscoelastic polymer.

7. The disk drive system as recited in claim 5, wherein the core material comprises a viscoelastic polymer.

8. An apparatus, comprising:
an electronic device having:
a drive mounted in the device chassis, the drive producing rotational vibration when operated; and
a constrained layer damping material connected to the electronic device in a manner to control the rotational vibration.

9. The apparatus as recited in claim 8, wherein the electronic device further comprises a carrier to which the drive is mounted, the carrier being removably received in the device chassis.

10. The apparatus as recited in claim 9, wherein the constrained layer damping material forms part of the carrier.

11. The apparatus as recited in claim 10, wherein the carrier comprises a pair of guide rails formed at least in part by the constrained layer damping material.

12. The apparatus as recited in claim 11, wherein the drive comprises a disk drive.

13. The apparatus as recited in claim 8, wherein the drive comprises a plurality of disk drives.

14. The apparatus as recited in claim 8, wherein the constrained layer damping material comprises a pair of layers sandwiching a core material.

15. The apparatus as recited in claim 14, wherein the pair of layers are formed of a metallic material.

16. The apparatus as recited in claim 15, wherein the core material comprises a viscoelastic polymer.

17. A method for reducing rotational vibration in an electronic device, comprising:
forming a vibration reduction material by sandwiching a thin viscoelastic core between stiffer sheets; and
mounting the vibration reduction material to the electronic device in the path of induced rotational vibration.

18. The method as recited in claim 17, wherein mounting comprises integrating the vibration reduction material into a guide rail of a drive carrier.

19. The method as recited in claim 17, wherein mounting comprises coupling the vibration reduction materials to a pair of guide rails and affixing the guide rails to a disk drive.

20. The method as recited in claim 17, wherein forming comprises placing the thin viscoelastic core between metal sheets.

21. A system for forming a disk drive system, comprising:
means for mounting a disk drive within a carrier; and
means for forming at least a portion of the carrier with a constrained layer damping material.

22. The system as recited in claim 21, wherein the means for mounting comprises a plurality of screws.

23. The system as recited in claim 21, wherein the means for forming comprises the constrained layer damping material integrated into a pair of guide rails.

24. The system as recited in claim 21, wherein the means for forming comprises a core disposed between at least two metal sheets.

25. The method as recited in claim 24, wherein the core comprises a polymeric layer between at least two metal sheets.
